(19) United States
(12) Patent Application Publication
(10) Pub. No.: US 2012/0026188 A1
(43) Pub. Date: Feb. 2, 2012

(54) HAND-HELD MOBILE APPARATUS CAPABLE OF QUICKLY DISPLAYING PICTURES AND METHOD OF QUICKLY DISPLAYING PICTURES APPLICABLE THERETO

(75) Inventors: ZHU CHEN, SHANGHAI CITY (CN); GANG CHEN, SHANGHAI CITY (CN); QI GUO, SHANGHAI CITY (CN)

(73) Assignees: MITAC RESEARCH (SHANGHAI) LTD., SHANGHAI (CN); MITAC INTERNATIONAL CORP., TAOYUAN COUNTY (TW)

(21) Appl. No.: 13/044,065

(22) Filed: Mar. 9, 2011

(30) Foreign Application Priority Data
Jul. 29, 2010 (TW) 099125198

(51) Int. Cl. G09G 5/00

(52) U.S. Cl. 345/619

(57) ABSTRACT

A hand-held mobile apparatus and a method capable of quickly displaying picture are disclosed. The method includes the steps of linking a communication unit to a server via a network system; storing a picture downloaded from the server in a storage unit; compressing the downloaded picture with an encoder unit, so that the compressed picture has a file size smaller than the downloaded picture; using a recognition unit to recognize whether the compressed picture is a head image; if yes, using a naming unit to specify a first file name to the compressed picture; storing the compressed picture in the storage unit; and displaying the compressed picture in a display screen. Further, a data buffer is provided to temporarily store the compressed picture transmitted by a control unit to the display screen, so that the compressed pictures can be quickly displayed on the hand-held mobile apparatus having the above units.

### FIELD OF THE INVENTION

The present invention relates to a hand-held mobile apparatus capable of quickly displaying pictures and a method of quickly displaying pictures applicable to the hand-held mobile apparatus; and more particularly to a method for quickly displaying online community friends' images on a hand-held mobile apparatus.

### BACKGROUND OF THE INVENTION

The social networking service (SNS) has built diversified online communities, and provides a good way for users of online communities to interact and contact with one another over the Internet. Through different social networking service websites, such as Facebook, Twitter, Plurk, Kaixin, Renren and the like, users can express and exchange their ideas, update personal profile within their individual online communities, and share pictures online. Therefore, such online communities are widely welcomed by the young generation and create a new era, in which diversified information is quickly exchanged among people. One of the core functions of the social networking service websites is to allow users in their online communities to share their pictures. The sharing of online community friends' head images increases the visibility and fun of interaction among online community friends.

Meanwhile, with the increasing progress in different technical fields, mobile electronic apparatus now have more powerful functions, allowing users to link to the social networking service websites directly via the mobile electronic apparatus to use the social networking services. However, the mobile electronic apparatus have processing unit and memory capacity that are not as good as those of general computers, and have limited network transmission speed and network flow. Therefore, the social networking service application programs for most of the currently commercially available mobile electronic apparatus omit the function of displaying online friends' pictures. Even if some of the mobile electronic apparatus still allow the user to use the social networking services, they require relatively long time to browse and display the online friends' images, and are therefore not welcomed among users. Under this circumstance, the mobile electronic apparatus lose their function of providing users with the visibility and convenience in sharing activities and exchanging images on the social networking service websites.

### SUMMARY OF THE INVENTION

A primary object of the present invention is to provide a hand-held mobile apparatus capable of quickly displaying pictures and a method of quickly displaying pictures applicable to the hand-held mobile apparatus.

To achieve the above and other objects, the hand-held mobile apparatus capable of quickly displaying pictures according to the present invention includes a control unit, to which a communication unit, an encoder unit, a recognition unit, a naming unit, a storage unit and a display screen are electrically connected. The communication unit is linked to a server via a network system, and the server has at least one picture stored therein. The storage unit is used to store at least one picture downloaded from the server. The encoder unit compresses the downloaded at least one picture into a compressed picture that has a file size smaller than that of the downloaded picture. The recognition unit recognizes whether the compressed picture matches a path characteristic. When the recognition unit recognizes that the compressed picture matches the path characteristic, the naming unit specifies a first file name to the compressed picture. The control unit controls all other units to work, stores the compressed picture in the storage unit, and provides the compressed picture to the display screen, so that the compressed picture is displayed in the display screen.

In the case the recognition unit recognizes that the compressed picture does not match the path characteristic, then the naming unit specifies a second file name to the compressed picture.

The compressed picture with the second file name is stored in the storage unit, and the control unit receives and transmits the compressed picture to the display screen, so that the compressed picture is displayed in the display screen.

The hand-held mobile apparatus of the present invention further includes a data buffer electrically connected to the control unit and the display screen for temporarily storing the compressed picture transmitted by the control unit to the display screen.

In the present invention, the first file name can be a username.

In the present invention, the second file name can be a combination of a username and a picture title.

To achieve the above and other objects, the method of quickly displaying pictures according to the present invention is applicable to a hand-held mobile apparatus. The hand-held mobile apparatus includes a control unit, to which a communication unit, an encoder unit, a recognition unit, a naming unit, a storage unit and a display screen are electrically connected. The method of quickly displaying pictures includes the following steps: first, linking the communication unit to a server via a network system; storing a picture downloaded from the server in the storage unit; using the encoder unit to compress the downloaded at least one picture into a compressed picture, such that the compressed picture has a file size smaller than that of the picture downloaded from the server; using the recognition unit to recognize whether the compressed picture matches a path characteristic; in the case the recognition unit recognizing that the compressed picture matches the path characteristic, using the naming unit to specify a first file name to the compressed picture; storing the compressed picture in the storage unit; transmitting the compressed picture to the control unit; using the control unit to transmit the compressed picture to the display screen; and displaying the compressed picture in the display screen.

In the method of the present invention, when the recognition unit recognizes that the compressed picture does not match the path characteristic, then the naming unit specifies a second file name to the compressed picture.

The compressed picture with the second file name is stored in the storage unit, and the control unit receives and transmits the compressed picture to the display screen, so that the compressed picture is displayed in the display screen.

The method of the present invention further includes the following step: providing a data buffer for temporarily storing the compressed picture transmitted by the control unit to the display screen.

In the present invention, the first file name can be a username.

In the present invention, the second file name can be a combination of a username and a picture title.

In brief, according to the hand-held mobile apparatus and the method of the present invention, the encoder unit can compress the pictures stored in the storage unit into compressed pictures having reduced file size, and the data buffer can temporarily store the compressed pictures that are frequently browsed by a user. Therefore, the problem of requiring a quite long time to display pictures as found in the prior art hand-held mobile apparatus can be solved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a hand-held mobile apparatus capable of quickly displaying pictures according to the present invention;

FIG. 2 is a conceptual view showing an embodiment of the present invention;

FIG. 3 schematically shows how the screen of a smart mobile phone according to an embodiment of the present invention quickly displays pictures; and

FIG. 4 is a flowchart showing the steps included in a method of quickly displaying online community friends' images according to the present invention.

### DETAILED DESCRIPTION OF THE PREFERRED EMBODIMENTS

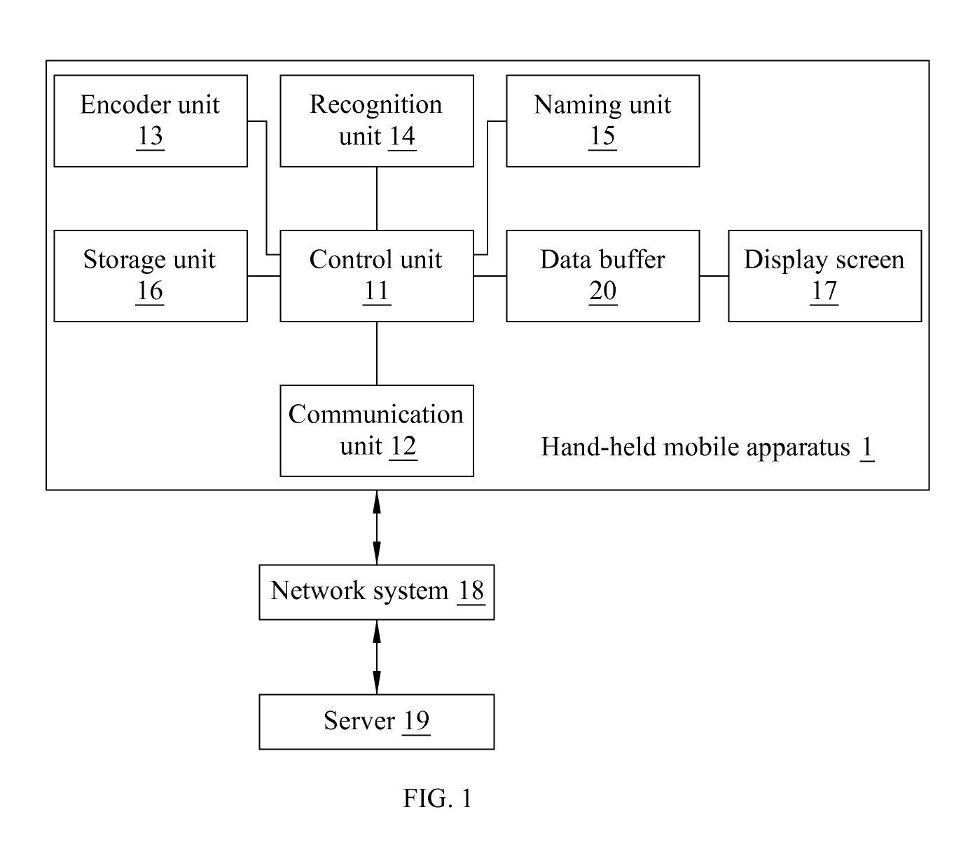

Please refer to FIG. 1 that is a block diagram of a hand-held mobile apparatus capable of quickly displaying pictures according to the present invention. For the purpose of conciseness, the hand-held mobile apparatus capable of quickly displaying pictures according to the present invention will also be briefly referred to as the hand-held mobile apparatus and generally denoted by reference numeral 1 herein. As shown, the hand-held mobile apparatus 1 includes a control unit 11 electrically connected to a communication unit 12, an encoder unit 13, a recognition unit 14, a naming unit 15, a storage unit 16, and a display screen 17. When a user wants to browse a social networking service (SNS) website, such as Facebook, Twitter, Plurk, or Myspace, the communication unit 12 can be linked to a server 19 of the SNS website via a network system 18, such as a telecommunication network or a wireless network. The server 19 has at least one picture stored therein. The control unit 11 downloads at least one picture from the server 19 via the communication unit 12, and stores the downloaded at least one picture in the storage unit 16. The storage unit 16 can be an internal memory card, an external memory card, or a flash memory. The encoder unit 13 compresses the downloaded at least one picture into a compressed picture, which has a file size smaller that that of the at least one downloaded picture. The recognition unit 14 recognizes whether the compressed picture matches a path characteristic. In the case the recognition unit 14 recognizes that the compressed picture matches the path characteristic, the naming unit 15 will then specify a first file name to the compressed picture, and the first file name can be a username. In the case the recognition unit 14 recognizes that the compressed picture does not match the path characteristic, the naming unit 15 will then specify a second file name to the compressed picture, and the second file name can be a combination of a username and a picture title. Then, the compressed picture with the username or the combination of the username and the picture title is stored in the storage unit 16. What is to be noted is the hand-held mobile apparatus 1 of the present invention further includes a data buffer 20 electrically connected to the control unit 11 and the display screen 17. The data buffer 20 serves to temporarily store the compressed picture transmitted by the control unit 11 to the display screen 17. Since the compressed pictures occupy a relatively small space in the memory and the data buffer 20 can temporarily store the compressed picture therein, a user browsing the SNS website can quickly browse the pictures provided by the website on the hand-held mobile apparatus to achieve the objective of quickly displaying pictures.

The encoder unit 13 can be a portable network graphics (PNG) encoder, or a joint photographic experts group (JPEG) encoder. In the case of a PNG encoder, the encoder unit 13 can encode a picture into a compressed picture with PNG format. A picture with PNG format has the characteristics of small volume and non-distortion, and is therefore very suitable for use with the hand-held mobile apparatus 1 having relatively small memory space. Or, in the case of a JPEG encoder, the encoder unit 13 can encode a picture into a compressed picture with JPEG format.

The recognition unit 14 is used to recognize whether the compressed picture matches a path characteristic or not. For example, the path characteristic can be “. . . public/uploads/HeadImage/picture title”. By “HeadImage”, it means a head image folder. Thus, all the pictures stored in this folder are considered as head images. A head image can be, for example, a representative head image on the upper left corner of the Facebook website for recognizing a friend. And, pictures that are not in the head image folder are considered as non-head images. A non-head image can be any picture other than the head image, such as a travel picture or daily life picture.

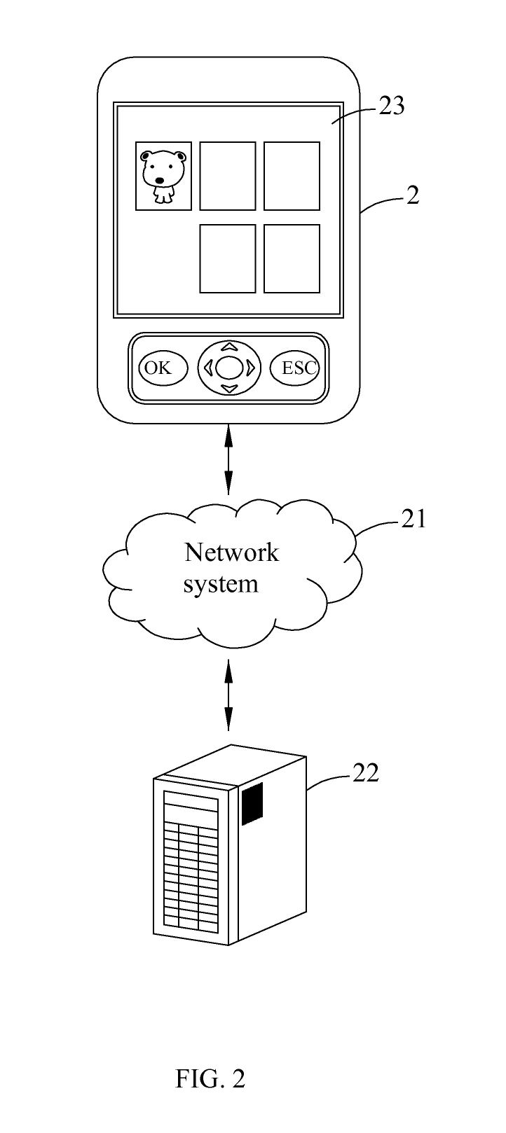

Please refer to FIG. 2 that is a conceptual view showing an embodiment of the hand-held mobile apparatus of the present invention. When the user wants to browse the Facebook website, he or she may use a smart mobile phone 2 to link to a server 22 of the Facebook website via a network system 21, such as a telecommunication network or a wireless network. The pictures on the Facebook website are compressed and then displayed on a display screen 23 of the smart mobile phone 2.

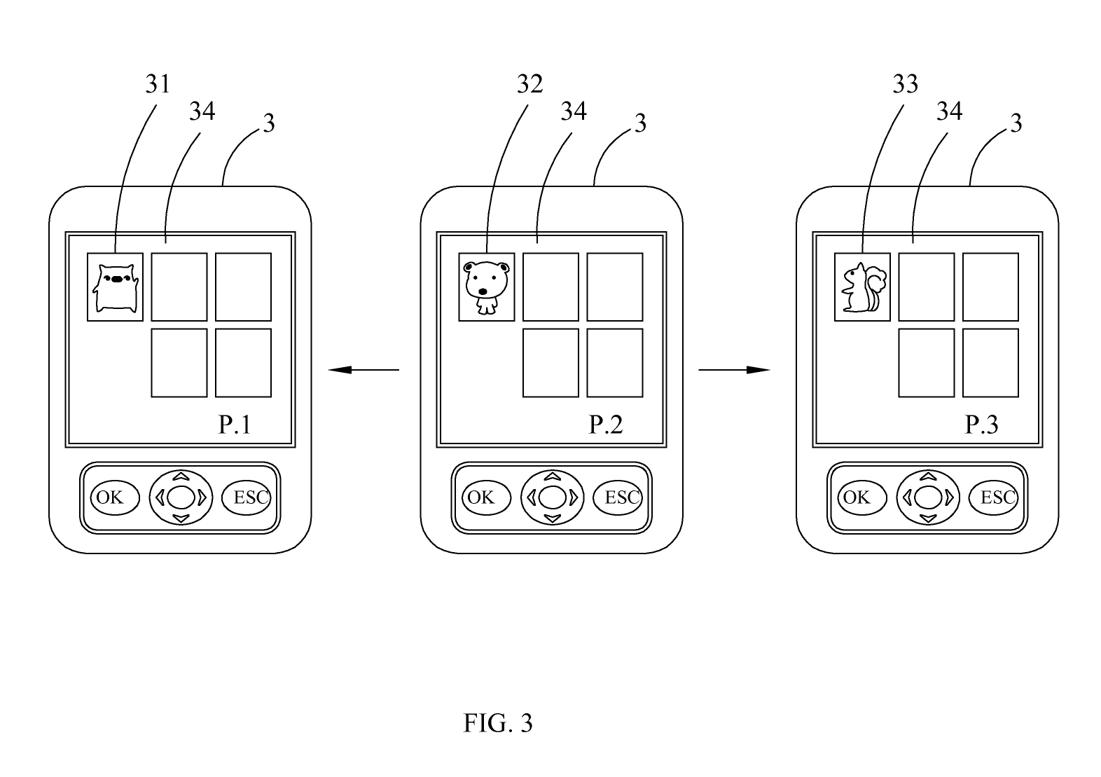

Please refer to FIG. 3 that schematically shows how a smart mobile phone 3 according to an embodiment of the present invention quickly displays pictures in a display screen 34 thereof When the user wants to browse the Facebook website, for example, he or she might be interested in browsing different friends' web pages. Since the smart mobile phone 3 is internally provided with a data buffer, the data buffer can be used to temporarily store the most frequently viewed pictures. For example, when the user is browsing pictures in a first friend's 32 web page and wants to shift to browse another friend's 31 or 33 web page, since the pictures are temporarily stored in the data buffer, these pictures can be quickly displayed in the display screen 34.

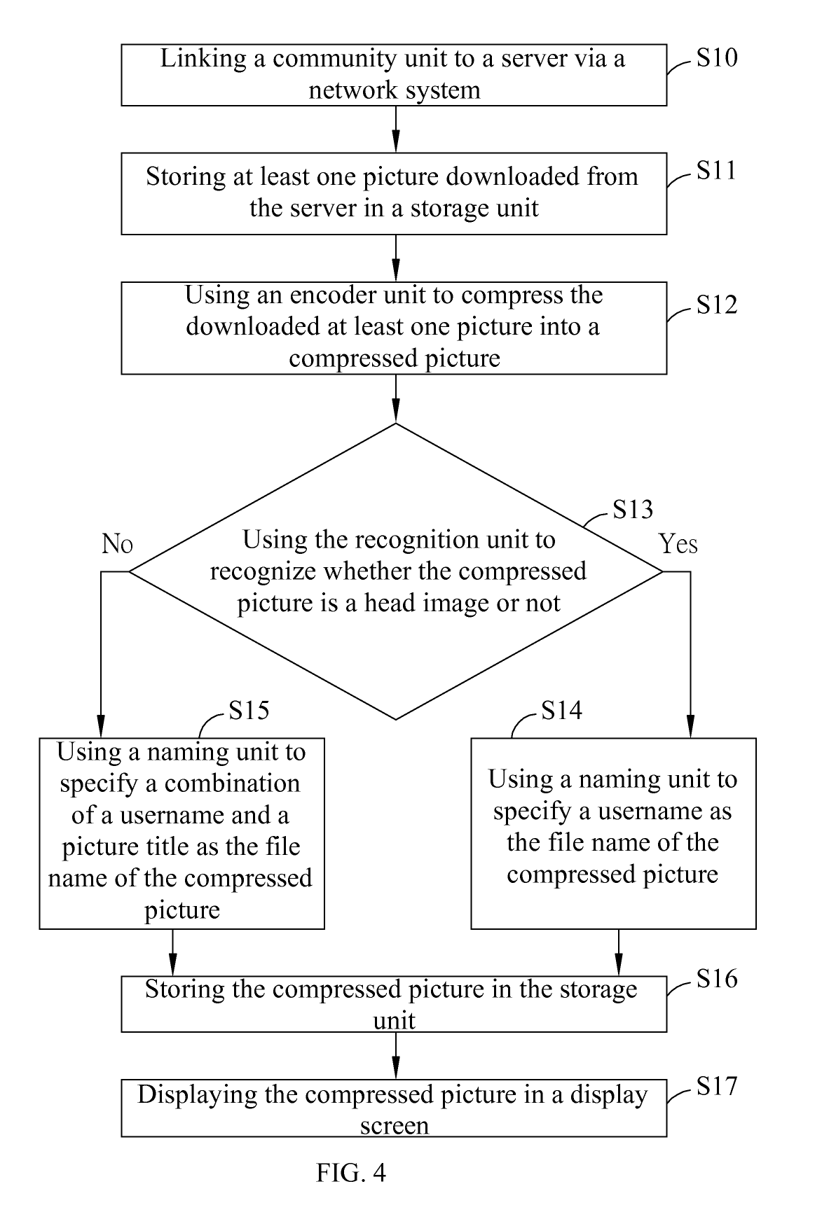

Please refer to FIG. 4 that is a flowchart showing the steps included in a method of quickly displaying online community friends' images according to the present invention. The method is applicable to a hand-held mobile apparatus having a communication unit, a storage unit, an encoder unit, a recognition unit, a naming unit, a control unit, a data buffer, and a display screen. The method includes the following steps:

S10: linking the communication unit to a server via a network system;

S11: storing at least one picture downloaded from the server in the storage unit;

S12: using the encoder unit to compress the downloaded at least one picture into a compressed picture, such that the compressed picture has a file size smaller than that of the picture downloaded from the server. The encoder unit can be a portable network graphics (PNG) encoder, or a joint photographic experts group (JPEG) encoder. In the case of a PNG encoder, the encoder unit can encode the picture into a compressed picture with PNG format. A picture with PNG format has the characteristics of small volume and non-distortion, and is therefore very suitable for use with a hand-held mobile apparatus having relatively small memory space. Or, in the case of a JPEG encoder, the encoder unit can encode a picture into a compressed picture with JPEG format.

S13: using the recognition unit to recognize whether the compressed picture is a head image or not. In the case the recognition unit determines the compressed picture is a head image, go to a step S14; or in the case the recognition unit determines the compressed picture is not a head image, go to a step S15.

S14: using the naming unit to specify a username as a file name of the compressed picture;

S15: using the naming unit to specify a combination of a username and a picture title as a file name to the compressed picture;

S16: storing the compressed picture in the storage unit; and

S17: displaying the compressed picture in the display screen.

The above-described method of quickly displaying online community friends' images further includes the following step: using the data buffer to temporarily store the compressed picture transmitted by the control unit to the display screen. In other words, pictures that are frequently browsed by the user will be temporarily stored in the data buffer.

Thus, when the user browses among previous pages and next pages, the pictures temporarily stored in the data buffer can be quickly displayed in the display screen. Therefore, the problem of requiring a quite long time to display pictures as found in the prior art hand-held mobile apparatus can be solved to achieve the object of quickly displaying pictures.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A hand-held mobile apparatus capable of quickly displaying pictures, comprising:
a communication unit linking to a server via a network system; the server having at least one picture stored therein;
a storage unit storing at least one picture downloaded from the server;
an encoder unit compressing the downloaded at least one picture into a compressed picture, such that the compressed picture has a file size smaller than that of the downloaded at least one picture;
a recognition unit recognizing whether the compressed picture matches a path characteristic or not;
a naming unit specifying a first file name to the compressed picture, provided the recognition unit recognizes that the compressed picture matches the path characteristic;
a display screen displaying the compressed picture; and
a control unit being electrically connected to the communication unit, the encoder unit, the recognition unit, the naming unit, the storage unit and the display screen for controlling the units connected thereto to work, storing the compressed picture in the storage unit, and providing the compressed picture to the display screen.

2. The hand-held mobile apparatus capable of quickly displaying pictures as claimed in claim 1, wherein in the case the recognition unit recognizes that the compressed picture does not match the path characteristic, the naming unit specifies a second file name to the compressed picture.

3. The hand-held mobile apparatus capable of quickly displaying pictures as claimed in claim 2, wherein the compressed picture with the second file name is stored in the storage unit, and the control unit receives and transmits the compressed picture to the display screen, so that the compressed picture is displayed in the display screen.

4. The hand-held mobile apparatus capable of quickly displaying pictures as claimed in claim 3, further comprising a data buffer electrically connected to the control unit and the display screen; and the data buffer temporarily storing the compressed picture that is transmitted by the control unit to the display screen.

5. The hand-held mobile apparatus capable of quickly displaying pictures as claimed in claim 2, wherein the first file name is a username, and the second file name is a combination of a username and a picture title.

6. A method of quickly displaying pictures applicable to a hand-held mobile apparatus, the hand-held mobile apparatus including a control unit, to which a communication unit, an encoder unit, a recognition unit, a naming unit, a storage unit and a display screen are electrically connected; the method comprising the following steps:
linking the communication unit to a server via a network system;
storing at least one picture downloaded from the server in the storage unit;
using the encoder unit to compress the downloaded at least one picture into a compressed picture, such that the compressed picture has a file size smaller than that of the picture downloaded from the server;
using the recognition unit to recognize whether the compressed picture matches a path characteristic;
in the case the recognition unit recognizing that the compressed picture matches the path characteristic, using the naming unit to specify a first file name to the compressed picture;
storing the compressed picture in the storage unit;
transmitting the compressed picture to the control unit;
using the control unit to transmit the compressed picture to the display screen; and
displaying the compressed picture in the display screen.

7. The method of quickly displaying pictures applicable to a hand-held mobile apparatus as claimed in claim 6, wherein in the case the recognition unit recognizes that the compressed picture does not match the path characteristic, use the naming unit to specify a second file name to the compressed picture.

8. The method of quickly displaying pictures applicable to a hand-held mobile apparatus as claimed in claim 7, wherein the compressed picture with the second file name is stored in the storage unit, and the control unit receives and transmits the compressed picture to the display screen, so that the compressed picture is displayed in the display screen.

9. The method of quickly displaying pictures applicable to a hand-held mobile apparatus as claimed in claim 8, further comprising the following step: providing a data buffer to temporarily store the compressed picture transmitted by the control unit to the display screen.

10. The method of quickly displaying pictures applicable to a hand-held mobile apparatus as claimed in claim 7, wherein the first file name is a username, and the second file name is a combination of a username and a picture title.
